(19) United States
(12) Patent Application Publication
(10) Pub. No.: US 2022/0147798 A1
(43) Pub. Date: May 12, 2022

(54) STATE CONTROL DEVICE, LEARNING DEVICE, STATE CONTROL METHOD, LEARNING METHOD, AND PROGRAM

(71) Applicant: Sony Interactive Entertainment Inc., Tokyo (JP)

(72) Inventor: Yoshinori Ohashi, Tokyo (JP)

(73) Assignee: Sony Interactive Entertainment Inc., Tokyo (JP)

(21) Appl. No.: 17/435,866

(22) PCT Filed: Mar. 29, 2019
(86) PCT No.: PCT/JP2019/014153

§ 371 Date: Sep. 2, 2021

(51) Int. Cl. G06N 3/04; G06N 3/08

(52) U.S. Cl. CPC G06N 3/0445; G06N 3/08

(57) ABSTRACT

A target input data acquiring section acquires target input data. A processing executing section executes processing that uses output data which is an output from an LSTM model into which the target input data is input. The loop processing including the acquisition of the target input data and the processing execution is repeatedly executed. A state control section controls whether or not to restrain the update of the states associated with the LSTM model, on the basis of at least one of the input data and the output data.

### TECHNICAL FIELD

The present invention relates to a state control device, a learning device, a state control method, a learning method, and a program.

### BACKGROUND ART

A long short-term memory (LSTM) model is known in which a unit in the intermediate layer of a recurrent neural network (RNN) model which is a machine learning model for processing a series of pieces of data such as time-series data is replaced with an LSTM block. In the LSTM model, the long-term state can be stored as the value of a state variable.

### SUMMARY

### Technical Problem

However, even in a neural network such as an LSTM model that can associate states, the states are not stored infinitely. Therefore, in a case where frequent input is performed, there is a case where the state is not stored for a sufficient period of time. For example, in an LSTM model in which 120 inputs are performed per second, there is a case where the value of a state variable is unintentionally reset in approximately a few seconds.

The present invention has been made in view of the above problem, and one of the objects thereof is to provide a state control device, a learning device, a state control method, a learning method, and a program which can prolong the period in which the state associated with the neural network is stored.

### Solution to Problem

In order to solve the above problem, a state control device according to the present invention includes an input data acquiring section that acquires input data, and a processing executing section that executes processing by using output data that is an output of a given neural network to which the input data is input, the neural network being capable of associating a state and being after learning. Loop processing including acquisition of the input data by the input data acquiring section and execution of the processing by the processing executing section is repeatedly executed. The state control device further includes a state control section that controls whether or not to restrict update of the state associated with the neural network, on the basis of at least one of the input data and the output data.

According to one aspect of the present invention, the state control section controls whether or not to input the input data to the neural network.

In the present aspect, in a case where the input data is controlled to be input to the neural network, the processing executing section may execute processing by using the output data which is an output when the input data is input to the neural network, and, in a case where the input data is controlled not to be input to the neural network, the processing executing section may execute processing by using the output data which is a latest output of the neural network.

Further, in one aspect of the present invention, the state control section controls whether or not to return the state updated in response to an input of the input data to the neural network to the state before the update.

Further, in one aspect of the present invention, an input determination model that is a machine learning model after execution of learning by using learning data including learning input data indicating an input to the neural network and teacher data indicating a difference between the output of the neural network corresponding to the input and the output of the neural network corresponding to the input immediately before the input is further included. The state control section controls whether or not to restrict the update of the state associated with the neural network, on the basis of the output when the input data acquired by the input data acquiring section is input to the input determination model.

Alternatively, the state control section controls whether or not to restrict the update of the state associated with the neural network, on the basis of a change from the input data acquired immediately before the input data for a part or all of the input data.

Alternatively, the state control section controls whether or not to restrict the update of the state associated with the neural network, on the basis of a change from the input data acquired immediately before the input data regarding a relative relation between elements included in the input data.

Alternatively, the state control section controls whether or not to restrict the update of the state associated with the neural network, on the basis of a comparison result between the output of the neural network corresponding to the input of the input data and the input data acquired next to the input data.

Further, in one aspect of the present invention, the neural network is an LSTM model.

In addition, a learning device according to the present invention includes a learning data acquiring section that acquires learning data including learning input data indicating an input to a given neural network that is capable of associating a state and is after learning, and teacher data indicating a difference between an output of the neural network corresponding to the input and an output of the neural network corresponding to the input immediately before the input, and a learning section that executes learning of an input determination model by using the output when the learning input data included in the learning data is input to the input determination model that is a machine learning model used to control whether or not to restrict update of the state associated with the neural network and by using the teacher data included in the learning data.

Further, a state control method according to the present invention includes a step of acquiring input data, and a step of executing processing by using output data that is an output of a given neural network to which the input data is input, the neural network being capable of associating a state and being after learning. Loop processing including acquisition of the input data and execution of the processing is repeatedly executed. The state control method further includes a step of controlling whether or not to restrict update of the state associated with the neural network, on the basis of at least one of the input data and the output data.

Still further, a learning method according to the present invention includes a step of acquiring learning data including learning input data indicating an input to a given neural network that is capable of associating a state and is after learning, and teacher data indicating a difference between an output of the neural network corresponding to the input and an output of the neural network corresponding to the input immediately before the input, and includes a step of executing learning of an input determination model by using the output when the learning input data included in the learning data is input to the input determination model that is a machine learning model used to control whether or not to restrict update of the state associated with the neural network and by using the teacher data included in the learning data.

Still further, a program according to the present invention causes a computer to execute a procedure of acquiring input data, and a procedure of executing processing by using output data that is an output of a given neural network to which the input data is input, the neural network being capable of associating a state and being after learning. Loop processing including acquisition of the input data and execution of the processing is repeatedly executed. The program causes the computer to further execute a procedure of controlling whether or not to restrict update of the state associated with the neural network, on the basis of at least one of the input data and the output data.

Still further, another program according to the present invention causes a computer to execute a procedure of acquiring learning data including learning input data indicating an input to a given neural network that is capable of associating a state and is after learning, and teacher data indicating a difference between an output of the neural network corresponding to the input and an output of the neural network corresponding to the input immediately before the input, and execute a procedure of executing learning of an input determination model by using the output when the learning input data included in the learning data is input to the input determination model that is a machine learning model used to control whether or not to restrict update of the state associated with the neural network and by using the teacher data included in the learning data.

### BRIEF DESCRIPTION OF DRAWINGS

FIG. 1 is a configuration diagram illustrating an example of an information processing device according to an embodiment of the present invention.

FIG. 2 is a diagram illustrating an example of an LSTM model.

FIG. 3 is a functional block diagram illustrating an example of functions implemented in the information processing device according to the embodiment of the present invention.

FIG. 4 is a flow chart illustrating an example of a flow of processing performed by the information processing device according to the embodiment of the present invention.

FIG. 5 is a functional block diagram illustrating an example of functions implemented in the information processing device according to the embodiment of the present invention.

FIG. 6 is a diagram schematically illustrating an example of learning of an input determination model.

FIG. 7 is a diagram illustrating an example of a learning data set.

FIG. 8 is a functional block diagram illustrating an example of functions implemented in the information processing device according to the embodiment of the present invention.

FIG. 9 is a flow chart illustrating an example of a flow of processing performed by the information processing device according to the embodiment of the present invention.

### DESCRIPTION OF EMBODIMENT

Hereinafter, an embodiment of the present invention will be described in detail with reference to the drawings.

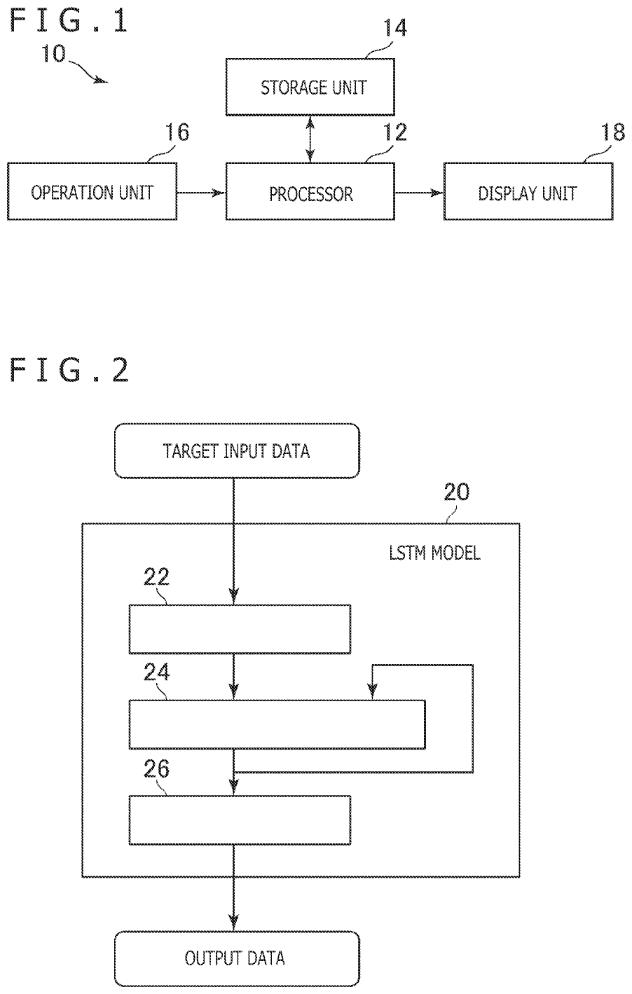

FIG. 1 is a configuration diagram of an information processing device 10 according to the embodiment of the present invention. The information processing device 10 according to the present embodiment is, for example, a computer such as a game console or a personal computer. As illustrated in FIG. 1, the information processing device 10 according to the present embodiment includes a processor 12, a storage unit 14, an operation unit 16, and a display unit 18, for example.

The processor 12 is, for example, a program control device such as a CPU (Central Processing Unit) that operates according to a program installed in the information processing device 10.

The storage unit 14 includes a storage element such as a ROM (Read-Only Memory) or a RAM (Random Access Memory), and a hard disk drive. The storage unit 14 stores a program or the like executed by the processor 12.

The operation unit 16 is a user interface such as a keyboard, a mouse, and a controller of a game console and receives an operation input of the user to output a signal indicating the contents to the processor 12.

The display unit 18 is a display device such as a liquid crystal display and displays various images according to the instructions of the processor 12.

Note that the information processing device 10 may include a communication interface such as a network board, an optical disk drive for reading an optical disk such as a DVD (Digital Versatile Disc)-ROM or a Blu-ray (registered trademark) disk, a USB (Universal Serial Bus) port, and the like.

The information processing device 10 according to the present embodiment is equipped with a given neural network, the neural network being capable of associating states and being after learning. In the following description, it is assumed that a given LSTM model 20 after learning illustrated in FIG. 2 is implemented in the information processing device 10 as an example of a given neural network, the neural network being capable of associating states and being after learning. The LSTM model 20 is a machine learning model for processing a series of pieces of data such as time-series data.

The LSTM model 20 illustrated in FIG. 2 includes an input layer 22, an LSTM block 24, and an output block 26.

The input layer 22 accepts inputs to the LSTM model 20. Hereinafter, the data input to the LSTM model 20 after learning will be referred to as target input data. In the present embodiment, a series of pieces of target input data, each piece of which is associated with a sequence number, is input to the input layer 22 in order according to the sequence numbers with which the pieces of data are associated.

When the target input data is input to the input layer 22, the data in which the target input data is combined with the output of the LSTM block 24 corresponding to the immediately preceding input (hereinafter referred to as combined input data) is input to the LSTM block 24.

The LSTM block 24 outputs an LSTM state variable that indicates the characteristics of the transition of the target input data such as the time-series transition of the target input data.

Then, a state variable that is an output from the LSTM block 24 is input to the output block 26. Then, the output block 26 outputs output data according to the input.

The output block 26 includes two intermediate layers and an output layer, for example. The two intermediate layers are fully connected layers having a rectified linear function (ReLU), for example, as an activation function. The output layer is a layer having a linear function as an activation function, for example.

In the present embodiment, the state variable which is the output from the LSTM block 24 is input to the first intermediate layer. Then, the output of the first intermediate layer is input to the second intermediate layer, and the output of the second intermediate layer is input to the output layer. Then, the output layer outputs the output data corresponding to the input.

In the LSTM model 20, the long-term state can be stored as the value of the state variable. However, even a given neural network after learning and capable of associating the states such as the LSTM model 20 does not store states indefinitely. Therefore, in a case where frequent input is performed, the state may not be saved for a sufficient period of time. For example, in the LSTM model 20 in which input is performed 120 times per second, there is a case where the value of the state variable is unintentionally reset in approximately several seconds.

Therefore, in the present embodiment, the period in which the state is stored can be extended in the neural network capable of associating the states as follows.

Hereinafter, the functions of the information processing device 10 according to the present embodiment and the processing executed by the information processing device 10 will be further described, focusing on prolonging the storage period of the state in the LSTM model 20.

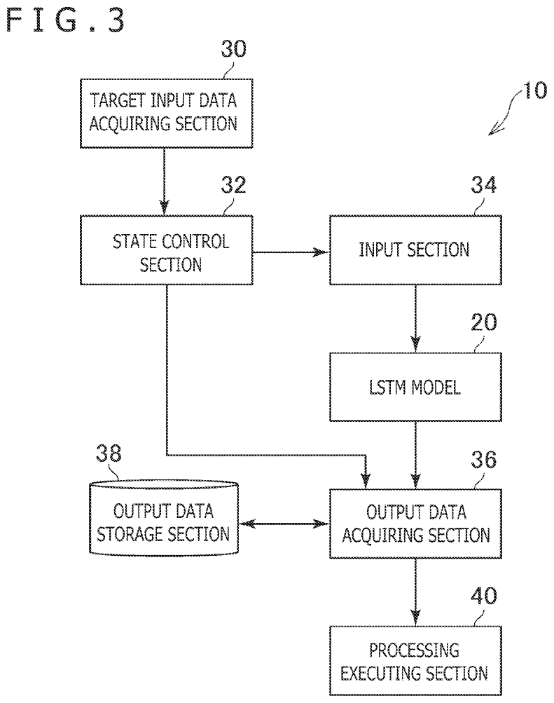

FIG. 3 is a functional block diagram illustrating an example of the functions implemented in the information processing device 10 according to the present embodiment. It should be noted that the information processing device 10 according to the present embodiment does not have to be equipped with all the functions illustrated in FIG. 3, and can be equipped with functions other than the functions illustrated in FIG. 3.

As illustrated in FIG. 3, the information processing device 10 according to the present embodiment functionally includes the LSTM model 20, a target input data acquiring section 30, a state control section 32, an input section 34, and an output data acquiring section 36, an output data storage section 38, and a processing executing section 40. The LSTM model 20 is mainly implemented in the processor 12 and the storage unit 14. The target input data acquiring section 30, the state control section 32, the input section 34, the output data acquiring section 36, and the processing executing section 40 are mainly implemented in the processor 12. The output data storage section 38 is mainly equipped in the storage unit 14.

The above functions may be implemented by executing, in the processor 12, the program including the instructions corresponding to the above functions and installed in the information processing device 10 which is a computer. This program may be supplied to the processor 12 via a computer-readable information storage medium such as an optical disk, a magnetic disk, a magnetic tape, a magneto-optical disk, or a flash memory, or via the Internet or the like.

In the present embodiment, the target input data acquiring section 30 acquires the above-mentioned target input data, for example.

In the present embodiment, the state control section 32 controls whether or not to restrict the update of the state associated with the given neural network after learning, on the basis of at least one of the target input data and the output data, for example. Here, the state control section 32 may control whether or not to input the target input data to the given LSTM model 20 after learning, on the basis of whether or not the target input data acquired by the target input data acquiring section 30 satisfies a predetermined condition.

In the present embodiment, in a case where the input section 34 is controlled by the state control section 32 to input the target input data to a neural network such as the LSTM model 20 that has already learned, the input section 34 inputs the target input data to the input layer 22 of the LSTM model 20.

As described above, the LSTM model 20 is a given LSTM model 20 after learning, which is an example of a given neural network, the neural network being capable of associating states and being after learning, for example, in the present embodiment. The LSTM model 20 holds state variables as described above. Then, the LSTM model 20 generates the combined input data in which the target input data to be input to the input layer 22 and the held state variables are combined. Then, the LSTM model 20 inputs the generated combined input data to the LSTM block 24. After that, the LSTM model 20 inputs the state variable output from the LSTM block 24 in response to the input, to the output block 26. Next, the output block 26 of the LSTM model 20 outputs output data corresponding to the state variable having been input.

Further, the LSTM model 20 updates the state variable by replacing the held state variable with the state variable output from the LSTM block 24. As described above, in the present embodiment, the value of the state variable held by the LSTM model 20 is updated according to the input to the input layer 22.

In the present embodiment, the output data acquiring section 36 acquires output data which is an output of the LSTM model 20, for example.

Here, in a case where the state control section 32 takes control so as to input the target input data to the LSTM model 20, the output data acquiring section 36 acquires the output data which is the output when the target input data is input to the LSTM model 20. In this case, the output data acquiring section 36 updates the output data by replacing the output data stored in the output data storage section 38 with the acquired output data.

On the other hand, in a case where the state control section 32 takes control so as not to input the target input data to the LSTM model 20, the output data acquiring section 36 acquires the output data which is the latest output of the LSTM model 20. Here, the output data acquiring section 36 may acquire the output data stored in the output data storage section 38, for example.

The output data storage section 38 stores the output data acquired by the output data acquiring section 36. Here, the output data storage section 38 may store the output data most recently acquired by the output data acquiring section 36.

In the present embodiment, the processing executing section 40 executes processing by using output data, which is the output of the LSTM model 20, for example.

The processing executing section 40 may execute processing by using the output data acquired by the output data acquiring section 36. For example, in the case where the state control section 32 takes control so as to input the target input data to the LSTM model 20, the processing executing section 40 may execute the processing by using the output data which is the output when the target input data is input to the LSTM model 20. Then, in the case where the state control section 32 takes control so as not to input the target input data to the LSTM model 20, the processing executing section 40 may execute processing by using the output data which is the latest output of the LSTM model 20. Here, for example, processing by using the output data stored in the output data storage section 38 may be executed.

In the present embodiment, the loop processing including the acquisition of the target input data by the target input data acquiring section 30, the control by the state control section 32, and the execution of the processing by the processing executing section 40 is repeatedly executed.

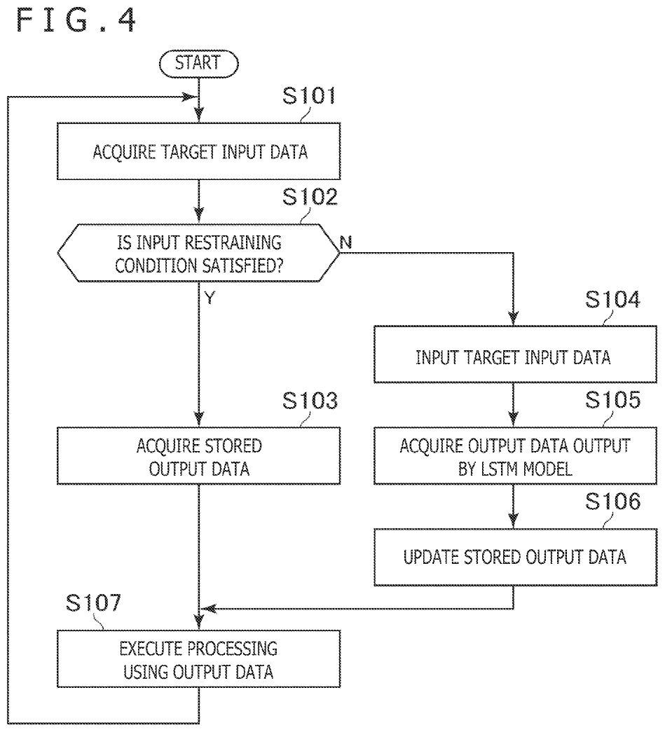

Here, an example of the flow of processing related to the state control of the LSTM model 20 performed in the information processing device 10 according to the present embodiment will be described with reference to the flow diagram illustrated in FIG. 4.

The processes illustrated in S101 to S107 illustrated in FIG. 4 are repeatedly executed at predetermined time intervals (for example, at 1/120 second intervals). Further, the processes indicated in S101 to S107 illustrated in FIG. 4 are executed in order according to the associated sequence number for each of the series of target input data pieces each of which is associated with the sequence number.

First, the target input data acquiring section 30 acquires the target input data to be processed in this loop (S101). Here, the target input data whose associated sequence number is next to the sequence number of the target input data for which the processes illustrated in S101 to S107 are executed in the immediately preceding loop is acquired.

Then, the state control section 32 determines whether or not the target input data acquired in the process illustrated in S101 satisfies a predetermined input restraining condition (S102).

In a case where it is determined that the input restraining condition is satisfied in the process illustrated in S102 (S102: Y), the output data acquiring section 36 acquires the output data stored in the output data storage section 38 (S103).

In a case where it is determined that the input restraining condition is not satisfied by the process illustrated in S102 (S102: N), the input section 34 inputs the target input data acquired in the process illustrated in S101 into the LSTM model 20 (S104). In this case, as described above, the combined input data in which the target input data and the LSTM state variable held by the LSTM model 20 are combined is input to the LSTM block 24. Further, the LSTM model 20 updates the state variable by replacing the held state variable with the state variable output by the LSTM block 24 in response to the input.

Then, the output data acquiring section 36 acquires the output data output by the LSTM model 20 in response to the input in the process illustrated in S104 (S105).

Then, the output data acquiring section 36 updates the output data by replacing the output data stored in the output data storage section 38 with the output data acquired by the process illustrated in S105 (S106).

Then, the processing executing section 40 executes processing by using the output data acquired by the output data acquiring section 36 in the process illustrated in S103 or S105 (S107), and returns to the process illustrated in S101.

In the present embodiment, as described above, it is controlled whether or not to restrict the update of the state associated with the neural network, on the basis of at least one of the target input data and the output data. For example, on the basis of the target input data, it is controlled whether or not the target input data is input to the LSTM model 20. Then, in a case where the target input data is not input to the LSTM model 20, the state variable of the LSTM is not updated. In this way, according to the present embodiment, the period in which the state is stored can be extended in a given neural network after learning and capable of associating the state such as the LSTM model 20.

Further, in the present embodiment, even in a situation where the target input data is not input to the LSTM model 20, the process using the output data which is the latest output of the LSTM model 20 is executed. Therefore, it does not take much time and effort to modify the implementation of the subsequent processing by using the output data in consideration of the situation where the target input data is not input to the neural network such as the LSTM model 20.

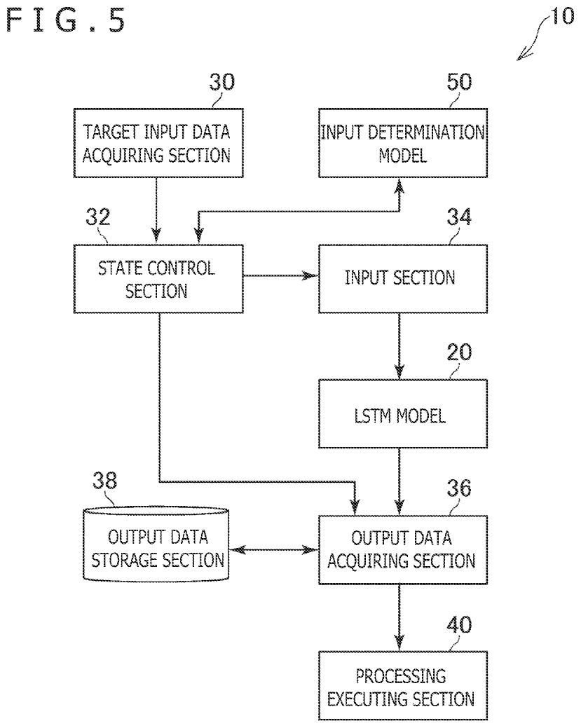

Further, in the present embodiment, as illustrated in FIG. 5, the information processing device 10 according to the present embodiment may include an input determination model 50, in addition to the elements illustrated in FIG. 3. The elements other than the input determination model 50 illustrated in FIG. 5 are similar to those illustrated in FIG. 3, and thus the description thereof will be omitted.

The input determination model 50 is a machine learning model after learning that is used to control whether or not to restrict the update of the state associated with the LSTM model 20 and that is different from the LSTM model 20. Here, the input determination model 50 is a machine learning model after learning which is used for controlling whether or not the target input data is input to the LSTM model 20 and is different from the LSTM model 20. The state control section 32 may control whether or not to input the target input data to the LSTM model 20, on the basis of the output when the target input data acquired by the target input data acquiring section 30 is input to the input determination model 50.

The input determination model 50 outputs the determination result data Dstop in response to the input of the target input data. Here, for example, the determination result data Dstop may be data having a value of either “0” or “1.”

In the present embodiment, for example, in a case where the determination result data Dstop whose value is “1” is output from the input determination model 50 in response to the input of the target input data, the target data is controlled so as not to be input to the LSTM model 20. Further, in a case where the determination result data Dstop whose value is “0” is output from the input determination model 50 in response to the input of the target input data, the target data is controlled to be input to the LSTM model 20.

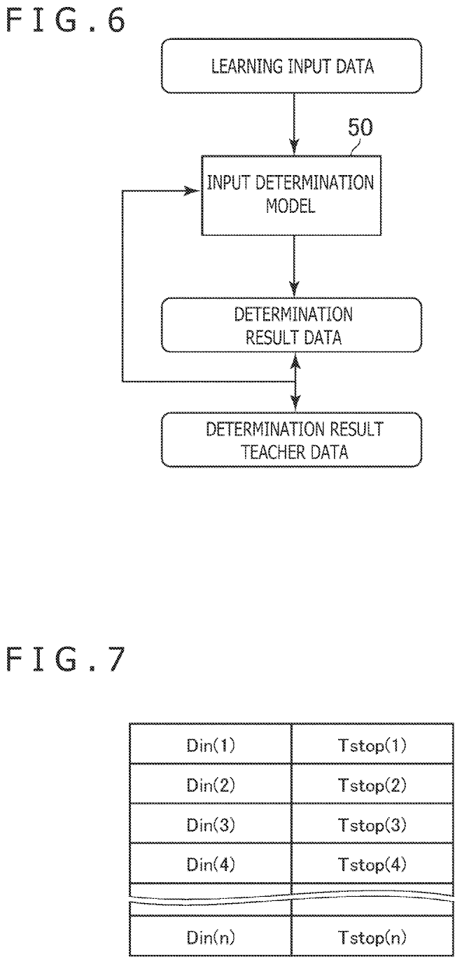

FIG. 6 is a diagram schematically illustrating an example of learning of the input determination model 50. In the input determination model 50, for example, learning by using a plurality of learning data sets is executed.

FIG. 7 is a diagram illustrating an example of a learning data set. The learning data set contains a plurality of pieces of learning data. The learning data includes, for example, learning input data Din to be input to the input determination model 50 and determination result teacher data Tstop which is the teacher data to be compared with the output of the input determination model 50 corresponding to the input. The plurality of pieces of learning input data included in the learning data set is a series of pieces of data (Din (1) to Din (n)) associated with a sequence number, such as time-series data. Then, Din (1) to Din (n) are associated with the determination result teacher data Tstop (1) to Tstop (n), respectively. Therefore, the determination result teacher data Tstop is also associated with the sequence number.

In the present embodiment, for example, the determination result teacher data Tstop is teacher data generated by using the LSTM model 20 which is a given machine learning model after learning. For example, when the learning input data Din (1) to Din (n) are sequentially input to the LSTM model 20 according to the associated sequence number, the outputs Dout (1) to Dout (n) corresponding to each input are identified. For example, the output Dout (1) of the LSTM model 20 in response to the input of the Din (1), the output Dout (2) of the LSTM model 20 in response to the input of the Din (2), . . . , and the output Dout (n) of the LSTM model 20 in response to the input of Din (n) are identified.

In a case where the absolute value of the difference between the output Dout of the LSTM model 20 and the output immediately before the output Dout is smaller than a predetermined threshold value, the value of Tstop corresponding to the output Dout is determined to be “1.” In a case where the absolute value of the difference between the output Dout of the LSTM model 20 and the output immediately before the output Dout is not smaller than the predetermined threshold value, the value of Tstop corresponding to the output Dout is determined to be “0.”

For example, in a case where the absolute value of Dout (2)−Dout (1) is smaller than a predetermined threshold value, the value of Tstop (2) is determined to be “1,” and in a case where the absolute value is not smaller than the threshold value, the value of Tstop (2) is determined to be “0.” In a case where the absolute value of Dout (n)−Dout (n−1) is smaller than a predetermined threshold value, the value of Tstop (n) is determined to be “1,” and in the case where the absolute value is not smaller than the threshold value, the value of Tstop (n) is determined to be “0.” Note that the value of Tstop (1) may be determined to be a predetermined value (for example, “0”).

For example, the values of the determination result teacher data Tstop (1) to Tstop (n) are determined as described above.

Then, a learning data set including the learning input data Din (1) to Din (n) and the determination result teacher data Tstop (1) to Tstop (n) is generated.

Then, learning of the input determination model 50 is executed by using the learning data set generated in this way. For example, the value of the determination result data Dstop (1) output by the input determination model 50 in response to the input of the learning input data Din (1) may be identified. Then, the parameters of the input determination model 50 may be updated by the error back propagation method (back propagation), on the basis of the difference between the value of the determination result data Dstop (1) and the value of the determination result teacher data Tstop (1). Next, the parameters of the input determination model 50 may be updated, on the basis of the difference between the value of Dstop (2) output by the input determination model 50 in response to the input of Din (2) and the value of Tstop (2). After that, a similar processing is executed, and finally, the parameter of the input determination model 50 may be updated, on the basis of the difference between the value of Dstop (n) which is the output corresponding to the input of Din (n) and the value of Tstop (n).

Then, in the present embodiment, for example, the learning of the input determination model 50 may be performed by executing the above-mentioned learning for each of the plurality of learning data sets. Incidentally, the number of pieces of learning data included in the learning data set used for learning of the input determination model 50 may or may not be the same.

Note that, in the above example, the learning of the input determination model 50 is executed by supervised learning, but the learning of the input determination model 50 may be executed by other methods such as unsupervised learning or reinforcement learning.

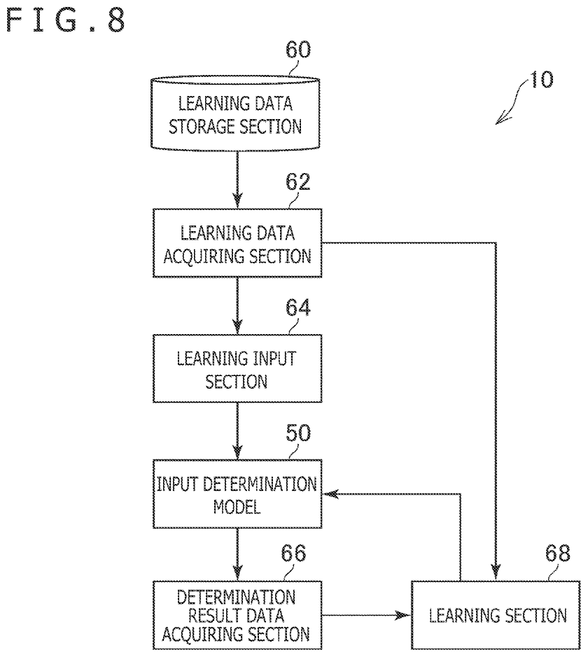

FIG. 8 is a functional block diagram illustrating an example of functions related to learning of the input determination model 50 implemented in the information processing device 10. Here, it is assumed that the learning of the input determination model 50 is executed in the information processing device 10, but the learning of the input determination model 50 may be executed in a device different from the information processing device 10. Further, it is not necessary that all the functions illustrated in FIG. 8 are implemented in the information processing device 10 according to the present embodiment, and functions other than the functions illustrated in FIG. 8 may be implemented.

As illustrated in FIG. 8, the information processing device 10 according to the present embodiment functionally includes the input determination model 50, a learning data storage section 60, a learning data acquiring section 62, a learning input section 64, a determination result data acquiring section 66, and a learning section 68, for example. The input determination model 50 is mainly implemented in the processor 12 and the storage unit 14. The learning data storage section 60 is mainly implemented in the storage unit 14. The learning data acquiring section 62, the learning input section 64, the determination result data acquiring section 66, and the learning section 68 are mainly implemented in the processor 12.

The above functions may be implemented by executing the program including the instructions corresponding to the above-mentioned functions and installed in the information processing device 10 which is a computer, in the processor 12. This program may be supplied to the processor 12 via a computer-readable information storage medium such as an optical disk, a magnetic disk, a magnetic tape, a magneto-optical disk, or a flash memory, or via the Internet or the like.

In the present embodiment, the learning data storage section 60 stores a plurality of learning data sets, for example. The learning data set contains a plurality of pieces of learning data. The learning data includes learning input data Din and determination result teacher data Tstop, for example. Here, the learning data set generated in advance using the LSTM model 20 as described above may be stored in the learning data storage section 60.

In the present embodiment, the learning data acquiring section 62 acquires the learning data stored in the learning data storage section 60, for example.

In the present embodiment, the learning input section 64 inputs the learning input data Din included in the learning data acquired by the learning data acquiring section 62, for example, into the input determination model 50.

In the present embodiment, the input determination model 50 is a machine learning model that outputs determination result data Dstop in response to input of learning input data Din, for example.

In the present embodiment, the determination result data acquiring section 66 acquires the determination result data Dstop output by the input determination model 50, for example.

In the present embodiment, the learning section 68 executes learning of the input determination model 50 by using the output when the learning input data Din is input to the input determination model 50, for example. Here, for example, the value of differences between the determination result data Dstop which is the output when the learning input data Din included in the learning data is input to the input determination model 50 and the value of the determination result teacher data Tstop included in the learning data may be identified. Then, supervised learning in which the value of the parameter of the input determination model 50 is updated, on the basis of the identified difference may be executed.

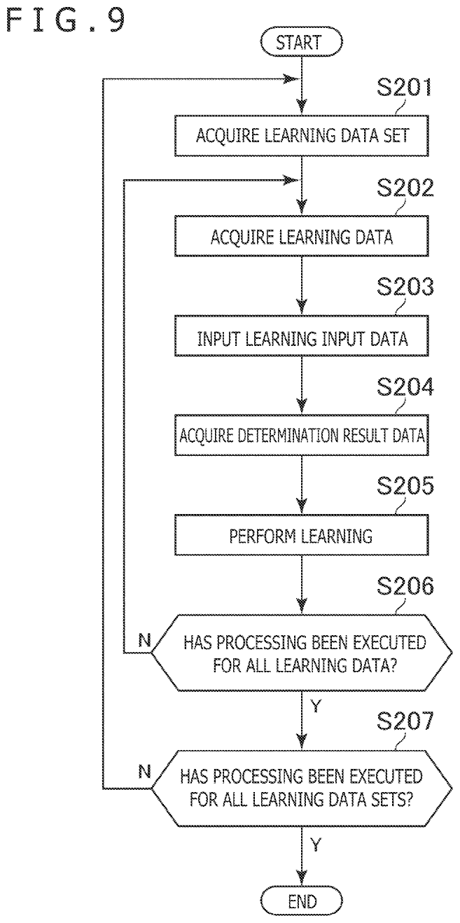

Here, an example of the flow of processing related to learning of the input determination model 50 performed in the information processing device 10 according to the present embodiment will be described with reference to the flow diagram illustrated in FIG. 9.

First, the learning data acquiring section 62 acquires one of the plurality of learning data sets which are stored in the learning data storage section 60 and for which the processes illustrated in S202 to S205 have not been executed (S201).

Then, the learning data acquiring section 62 acquires a piece of learning data which is included in the learning data set acquired by the process illustrated in S201, and for which the processes illustrated in S203 to S205 have not been executed, and further whose associated sequence number is the smallest (S202).

Then, the learning input section 64 inputs the learning input data Din included in the learning data acquired in the process illustrated in S202 into the input determination model 50 (S203).

Then, the determination result data acquiring section 66 acquires the determination result data Dstop output by the input determination model 50 in response to the input in the process illustrated in S203 (S204).

Then, the learning section 68 performs learning of the input determination model 50, which uses the determination result data Dstop acquired in the process illustrated in S204 and the determination result teacher data Tstop included in the learning data acquired in the process illustrated in S202 (S205). Here, for example, the value of the parameter of the input determination model 50 may be updated, on the basis of the difference between the value of the determination result data Dstop and the value of the determination result teacher data Tstop.

Then, the learning section 68 confirms whether or not the processes illustrated in S203 to S205 have been executed for all the learning data included in the learning data set acquired in the process illustrated in S201 (S206).

In a case where the processes illustrated in S203 to S205 have not been executed for all the learning data included in the learning data set acquired in the process illustrated in S201 (S206: N), the procedure returns to the process illustrated in S202.

On the other hand, it is assumed that the processes illustrated in S203 to S205 have been executed for all the learning data included in the learning data set acquired by the process illustrated in S201 (S206: Y). In this case, the learning section 68 confirms whether or not the processes illustrated in S202 to S205 have been executed for all the learning data sets stored in the learning data storage section 60 (S207).

In a case where the processes illustrated in S202 to S205 have not been executed for all the learning data sets stored in the learning data storage section 60 (S207: N), the procedure returns to the process illustrated in S201.

In a case where the processes illustrated in S202 to S205 have been executed for all the learning data sets stored in the learning data storage section 60 (S207: Y), the procedure illustrated in this processing example are terminated.

Then, using the input determination model 50 after learning that is generated as described above, it may be controlled whether or not to restrict the update of the state associated with the given neural network after learning. For example, using the generated input determination model 50 after learning, it may be controlled whether or not the target input data is input to the LSTM model 20 after learning. In this case, for example, it may be controlled whether or not the state control section 32 restricts the update of the state associated with the given neural network after learning, on the basis of the output when the target input data is input to the input determination model 50. For example, the state control section 32 may control whether or not to input the target input data into the LSTM model 20, on the basis of the output when the target input data is input to the input determination model 50.

For example, in the process illustrated in S102 described above, the state control section 32 may input the target input data acquired in the process illustrated in S101 into the input determination model 50 after learning. Then, the state control section 32 may acquire the determination result data Dstop output by the input determination model 50 in response to the input.

Then, in a case where the value of the determination result data Dstop is “1,” the state control section 32 may determine that the input restraining condition is satisfied. In this case, in the process illustrated in S103, the output data acquiring section 36 acquires the output data stored in the output data storage section 38.

Further, in a case where the value of the determination result data Dstop is “0,” the state control section 32 may determine that the input restraining condition is not satisfied. In this case, in the process illustrated in S104, the input section 34 inputs the target input data acquired in the process illustrated in S101 into the LSTM model 20.

The scope of application of the present embodiment is not limited to a specific technical field.

For example, the present embodiment can be applied to body tracking. Here, for example, it is assumed that the LSTM model 20 is a machine learning model after learning, in which time-series sensing data that is a measurement result of a sensor included in a tracker attached to the end of the user's body, is input. Then, it is assumed that the LSTM model 20 outputs output data indicating the estimation result of the posture of a body part closer than the end to the center of the body in response to the input. Here, for example, the LSTM model 20 outputs output data indicating the posture of a wrist in response to input of sensing data indicating the posture of the user's hand. Then, using the output data, it is assumed that a body tracking process including a process of determining the postures of a plurality of parts included in the user's body is executed.

In such a situation, according to the present embodiment, whether or not the sensing data is input to the LSTM model 20 may be controlled. For example, in a case where the absolute value of the value indicating the change in the posture of the hand is smaller than a predetermined threshold value, the sensing data may be prevented from being input into the LSTM model 20.

Further, for example, the present embodiment can be applied to image analysis. Here, for example, it is assumed that a plurality of frame images included in the video data are sequentially input according to the frame numbers in the machine learning model after learning in which the CNN model and the LSTM model 20 are combined. Then, it is assumed that the machine learning model outputs output data indicating the feature amount of the frame image having been input, in response to the input. Then, using the output data, image analysis processing such as identification of an image of an object appearing in the frame image may be executed.

In such a situation, according to the present embodiment, whether or not the frame image is input to the machine learning model including the LSTM model 20 may be controlled. For example, in a case where the absolute value of the value indicating the change from a frame image immediately before the frame image is smaller than a predetermined threshold value, the frame image may be prevented from being input to the LSTM model 20.

Further, in the present embodiment, the control of whether or not to restrict the update of the state associated with the neural network is not limited to the above examples.

For example, the state control section 32 may control whether or not to restrict the update of the state associated with the LSTM model 20 after learning, on the basis of the change from the target input data acquired immediately before for a part or all of the target input data. For example, in a case where the change in a part or all of the target input data is small, the state control section 32 may take control not to input the target input data into the LSTM model 20 after learning. Further, in a case where the change in a part or all of the target input data is large, the state control section 32 may take control to input the target input data into the LSTM model 20 after learning.

Further, for example, the state control section 32 may identify the difference between the value of the target input data and the value of target input data acquired immediately before the target input data. Then, the state control section 32 may control whether or not to restrict the update of the state associated with the LSTM model 20 after learning, on the basis of the identified difference. Here, for example, the state control section 32 may control whether or not to input the target input data into the LSTM model 20 after learning, on the basis of the magnitude of the absolute value of the identified difference.

For example, in a case where the absolute value of the identified difference is smaller than a predetermined threshold value, the state control section 32 may take control not to input the target input data into the LSTM model 20 after learning. In contrast, when the absolute value of the identified difference is not smaller than the predetermined threshold value, the state control section 32 may take control to input the target input data into the LSTM model 20 after learning.

Further, for example, the state control section 32 may control whether or not to restrict the update of the state associated with the LSTM model 20 after learning, on the basis of the change from the target input data acquired immediately before, regarding the relative relation between the elements included in the target input data. For example, in a case where the change in the relative relation between the elements included in the target input data is small, the state control section 32 may take control so as not to input the target input data into the LSTM model 20 after learning. Further, in a case where the change in the relative relation between the elements included in the target input data is large, the state control section 32 may take control so as to input the target input data into the LSTM model 20 after learning.

Further, the state control section 32 may control whether or not to return the state updated in response to the input of the target input data to the neural network such as the LSTM model 20 to the state before the update. For example, whether or not to return the state associated with the LSTM model 20 to the state before the update may be controlled, on the basis of the change from the output data output immediately before the output data for a part or all of the output data. For example, in a case where the change in a part or all of the output data is small, the state control section 32 may take control so that the state updated in response to the input of the target input data to the LSTM model 20 returns to the immediately preceding state. Further, in a case where the change in a part or all of the output data is large, the state updated in response to the input of the target input data to the LSTM model 20 may be maintained.

Further, for example, the state control section 32 may compare the output of the LSTM model 20 in response to the input of the target input data with a target input data acquired next to the target input data. Then, the state control section 32 may control whether or not to restrict the update of the state associated with the LSTM model 20, on the basis of the result of the comparison. In this case as well, as described above, it may be controlled whether or not the state updated in response to the input of the target input data to the LSTM model 20 is returned to the state before the update.

For example, in the above-mentioned body tracking, it is assumed that the LSTM model 20 outputs data indicating a head posture in the future in response to the input of data indicating a head posture and a hand posture, which are measurement results by a sensor. In this case, in a case where the absolute value of the difference between the data output from the LSTM model 20 and the data indicating the head posture, which is the measurement result in the next loop processing, is smaller than a predetermined threshold value, update in the state associated with the LSTM model 20 may be restricted.

Further, in the present embodiment, in a case where the condition in which the output data does not change is obvious, whether or not the target input data is input to the LSTM model 20 after learning may be controlled, on the basis of the condition. In addition, if the condition in which the output data does not change is known in advance in relation to the applied use case from the empirical rule, whether or not to input the target input data to the LSTM model 20 after learning may be controlled, on the basis of the condition.

The present invention is not limited to the above-described embodiments.

The present invention is also applicable to a given neural network after learning, which can somehow associate states, other than the LSTM model 20, for example. The present invention may be applied separately to each element (CEC, Input Gate, Output Gate, Forget Gate) included in the LSTM model 20, for example. Further, the present invention is also applicable to an RNN model capable of associating states, which is not the LSTM model 20. In addition, the present invention is also applicable to a neural network in which the current value of a specific layer (for example, a fully connected layer) is taken out and the value is used for the next input. In this case, the value of the specific layer corresponds to the value of the state variable.

The “state associated with the neural network” in the present invention is not limited to the state (internal state) of a certain layer of the neural network that is taken over by the next loop. The “state” includes states which are not used as the state of a certain layer in the next loop, but stored in association with the neural network and used for input and output in the next loop. For example, the present invention is applicable to a neural network which can output the state of a certain layer of the neural network, and in which the output can be given as an input for the next loop to be set as the initial value of the state of the layer in the loop. Further, the present invention can also be applied to a neural network which can output the state of a certain layer of the neural network and in which the output is given as an input of the next loop, but is not used as an initial value of the state of the layer in the loop. In addition, the present invention is also applicable to a neural network in which the state of a certain layer of the neural network is taken over from the immediately preceding input/output and used as an initial value in the input/output of the next loop.

Further, the above-mentioned specific character strings and numerical values, and specific character strings and numerical values in the drawings are examples, and thus the character strings and numerical values are not limited to these.

1. A state control device comprising:
an input data acquiring section that acquires input data; and
a processing executing section that executes processing by using output data that is an output of a given neural network to which the input data is input, the neural network being capable of associating a state and being after learning, wherein
loop processing including acquisition of the input data by the input data acquiring section and execution of the processing by the processing executing section is repeatedly executed, and
the state control device further includes a state control section that controls whether or not to restrict update of the state associated with the neural network, on a basis of at least one of the input data and the output data.

2. The state control device according to claim 1, wherein the state control section controls whether or not to input the input data to the neural network.

3. The state control device according to claim 2, wherein,
in a case where the input data is controlled to be input to the neural network, the processing executing section executes the processing by using the output data that is an output when the input data is input to the neural network, and,
in a case where the input data is controlled not to be input to the neural network, the processing executing section executes the processing by using the output data that is a latest output of the neural network.

4. The state control device according to claim 1, wherein
the state control section controls whether or not to return the state updated in response to an input of the input data to the neural network to the state before the update.

5. The state control device according to claim 1, further comprising:
an input determination model that is a machine learning model after execution of learning by using learning data including learning input data indicating an input to the neural network and teacher data indicating a difference between the output of the neural network corresponding to the input and the output of the neural network corresponding to the input immediately before the input, wherein
the state control section controls whether or not to restrict the update of the state associated with the neural network, on a basis of the output when the input data acquired by the input data acquiring section is input to the input determination model.

6. The state control device according to claim 1, wherein the state control section controls whether or not to restrict the update of the state associated with the neural network, on a basis of a change from the input data acquired immediately before the input data for a part or all of the input data.

7. The state control device according to claim 1, wherein the state control section controls whether or not to restrict the update of the state associated with the neural network, on a basis of a change from the input data acquired immediately before the input data regarding a relative relation between elements included in the input data.

8. The state control device according to claim 1, wherein the state control section controls whether or not to restrict the update of the state associated with the neural network, on a basis of a comparison result between the output of the neural network corresponding to the input of the input data and the input data acquired next to the input data.

9. The state control device according to claim 1, wherein the neural network is a long short-term memory model.

10. A learning device comprising:
a learning data acquiring section that acquires learning data including learning input data indicating an input to a given neural network that is capable of associating a state and is after learning, and teacher data indicating a difference between an output of the neural network corresponding to the input and an output of the neural network corresponding to the input immediately before the input; and
a learning section that executes learning of an input determination model by using the output when the learning input data included in the learning data is input to the input determination model that is a machine learning model used to control whether or not to restrict update of the state associated with the neural network and by using the teacher data included in the learning data.

11. A state control method comprising:
acquiring input data; and
executing processing by using output data that is an output of a given neural network to which the input data is input, the neural network being capable of associating a state and being after learning, wherein
loop processing including acquisition of the input data and execution of the processing is repeatedly executed, and
the state control method further includes controlling whether or not to restrict update of the state associated with the neural network, on a basis of at least one of the input data and the output data.

12. A learning method comprising:
acquiring learning data including learning input data indicating an input to a given neural network that is capable of associating a state and is after learning, and teacher data indicating a difference between an output of the neural network corresponding to the input and an output of the neural network corresponding to the input immediately before the input; and
executing learning of an input determination model by using the output when the learning input data included in the learning data is input to the input determination model that is a machine learning model used to control whether or not to restrict update of the state associated with the neural network and by using the teacher data included in the learning data.

13. A non-transitory, computer readable storage medium containing a computer program, which when executed by a computer, causes the computer to perform a state control method by carrying out actions, comprising:
acquiring input data; and
executing processing by using output data that is an output of a given neural network to which the input data is input, the neural network being capable of associating a state and being after learning, wherein
loop processing including acquisition of the input data and execution of the processing is repeatedly executed, and
the method further includes controlling whether or not to restrict update of the state associated with the neural network, on a basis of at least one of the input data and the output data.

14. A non-transitory, computer readable storage medium containing a computer program, which when executed by a computer, causes the computer to perform a learning method by carrying out actions, comprising:
acquiring learning data including learning input data indicating an input to a given neural network that is capable of associating a state and is after learning, and teacher data indicating a difference between an output of the neural network corresponding to the input and an output of the neural network corresponding to the input immediately before the input; and
executing learning of an input determination model by using the output when the learning input data included in the learning data is input to the input determination model that is a machine learning model used to control whether or not to restrict update of the state associated with the neural network and by using the teacher data included in the learning data.
